(19) United States
(12) Patent Application Publication
(10) Pub. No.: US 2017/0254592 A1
(43) Pub. Date: Sep. 7, 2017

(54) THERMAL TREATMENT DEVICE

(71) Applicants: IHI Corporation, Tokyo (JP); IHI Machinery and Furnace Co., Ltd., Tokyo (JP)

(72) Inventor: Kazuhiko KATSUMATA, Inuyama-shi (JP)

(73) Assignees: IHI Corporation, Tokyo (JP); IHI Machinery and Furnace Co., Ltd., Tokyo (JP)

(21) Appl. No.: 15/599,062

(22) Filed: May 18, 2017

Related U.S. Application Data
(63) Continuation of application No. PCT/JP2016/054103, filed on Feb. 12, 2016.

(30) Foreign Application Priority Data
Apr. 2, 2015 (JP) 2015-076119

(51) Int. Cl. F27D 7/06; C21D 1/773

(52) U.S. Cl. CPC F27D 7/06; C21D 1/773; F27D 2007/066; F27D 2007/063

(57) ABSTRACT

A thermal treatment device includes a heating chamber which heats an object to be treated; and a moisture removal chamber which is provided adjacent to the heating chamber to put in and out of the object to be treated toward the heating chamber, and in which a vacuum atmosphere is created in the periphery of the object to be treated.

### CROSS-REFERENCE TO RELATED APPLICATIONS

This application is a continuation application based on a PCT Patent Application No. PCT/JP2016/054103, filed Feb. 12, 2016, whose priority is claimed to Japanese Patent Application No. 2015-076119, filed Apr. 2, 2015. The contents of both the PCT Application and the Japanese Application are incorporated herein by reference.

### TECHNICAL FIELD

The present disclosure relates to a thermal treatment device.

### BACKGROUND ART

The following Patent Document 1 discloses a thermal treatment furnace (two-chamber type thermal treatment device) which includes a thermal treatment chamber that thermal-treats an object to be treated, and a carrying-in chamber that carries the object to be treated into the thermal treatment chamber. The thermal treatment furnace includes a vaporization device which vaporizes moisture in the carrying-in chamber, and an exhaust device which exhausts the moisture vaporized by the vaporization device to the outside of the carrying-in chamber. The thermal treatment furnace removes the moisture adhering to the object to be treated by using the vaporization device to blow hot air onto the object to be treated in the carrying-in chamber before conveying the object to be treated to the thermal treatment chamber, thereby suppressing oxidation and coloration of the object to be treated.

### CITATION LIST

### Patent Document

Patent Document 1

Japanese Unexamined Patent Application, First Publication No. 2011-241469

### SUMMARY

However, in the aforementioned conventional technique, it is not possible to sufficiently remove the moisture adhering to the object to be treated. For example, when the object to be treated onto which hot air is blown has a complicated shape or when the object to be treated onto which hot air is blown is stacked in multiple stages, even if its shape is comparatively simple, there are situations in which hot air is not blown over the entire surface of the object to be treated but is blown only locally. In such a case, it is not possible to reliably remove moisture adhering to the object to be treated, and thus it is not possible to sufficiently suppress the oxidation and coloration of the object to be treated.

The present disclosure has been made in view of the above-described circumstances, and an object of the present disclosure is to remove moisture adhering to an object to be treated more reliably than in the conventional case.

In order to achieve the aforementioned object, a first aspect of the present disclosure provides a thermal treatment device including a heating chamber which heats an object to be treated, and a moisture removal chamber which is provided adjacent to the heating chamber to put in and out of the object to be treated toward the heating chamber, and in which a vacuum atmosphere is created in the periphery of the object to be treated.

According to the present disclosure, since the moisture removal chamber creates a vacuum atmosphere in the periphery of the object to be treated, it is possible to vaporize the moisture adhering to the entire surface of the object to be treated. Therefore, according to the present disclosure, it is possible to reduce the oxidation or coloration of the surface of the object to be treated generated due to moisture when the object to be treated is thermal-treated more reliably than in the conventional case.

### BRIEF DESCRIPTION OF DRAWINGS

FIG. 1 is a front cross-sectional view showing an overall configuration of a two-chamber type thermal treatment device according to an embodiment of the present disclosure.

FIG. 2 is a flowchart showing the operation of the two-chamber type thermal treatment device according to an embodiment of the present disclosure.

### DESCRIPTION OF EMBODIMENTS

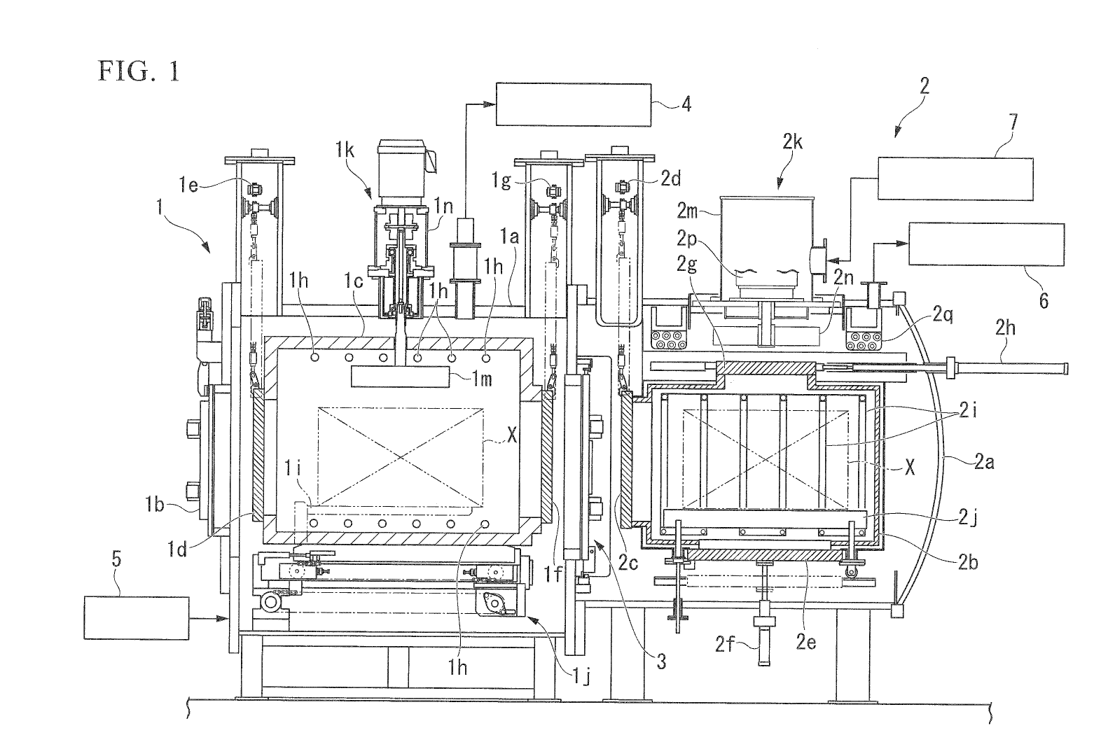

Hereinafter, an embodiment of the present disclosure will be described with reference to FIG. 1.

As shown in FIG. 1, a two-chamber type thermal treatment device according to the present embodiment is a device that performs thermal treatment on an object X to be treated, and includes a moisture removal chamber 1, a heating and cooling chamber 2 (heating chamber), a middle door 3, a first vacuum pump 4, a first nitrogen tank 5 (inert gas supply unit), a second vacuum pump 6 and a second nitrogen tank 7. The object X to be treated is any of various components made of a metal, and the two-chamber type thermal treatment device performs quenching treatment, which is one type of thermal treatment for a metal, on the object X to be treated.

As shown in the figure, the moisture removal chamber 1 is provided adjacent to the heating and cooling chamber 2, and puts in and out of the object X to be treated toward the heating and cooling chamber 2, and removes moisture adhering to the object X to be treated by creating a vacuum atmosphere in the periphery of the object X to be treated. The moisture removal chamber 1 includes a vacuum chamber 1a, a carrying-in-and-out door 1b, a heat insulating container 1c, a first heat insulating door 1d, a first elevator 1e, a second heat insulating door 1f, a second elevator 1g, a heater 1h (heating unit), a mounting table 1i, a loading and unloading mechanism 1j, and a stirring device 1k.

The vacuum chamber 1a is a horizontally placed cylindrical metal container having airtightness, and constitutes a wall body of the moisture removal chamber 1. The carrying-in-and-out door 1b is a slide door which is provided in a vertical posture at an end portion of the vacuum chamber 1a opposite to the heating and cooling chamber 2, that is, at a left side end portion of FIG. 1. The carrying-in-and-out door 1b is supported by the vacuum chamber 1a to be slidable in a left-right direction when the carrying-in-and-out door 1b is viewed from the front. When the carrying-in-and-out door 1b is in an open state, the inside of the vacuum chamber 1a (inside of the moisture removal chamber 1) communicates with an external space, and when the carrying-in-and-out door 1b is in a closed state, communication between the inside of the vacuum chamber 1a (inside of the moisture removal chamber 1) and the external space is shut off.

The heat insulating container 1c is a substantially cubic container formed of a heat insulating material and is housed in the vacuum chamber 1a. Inside the heat insulating container 1c, the object X to be treated carried into the vacuum chamber 1a from the carrying-in-and-out door 1b is housed as shown in the figure. As the heat insulating material which forms the heat insulating container 1c, for example, a wool-based heat insulating material such as graphite wool or ceramic wool is used.

In the heat insulating container 1c, the left end portion and the right end portion are opened. The first heat insulating door 1d is a plate-like member formed of a heat insulating material similar to that of the heat insulating container 1c, and is provided in a vertical posture at the left end portion (open end portion) of the heat insulating container 1c. The first heat insulating door 1d is provided at the left end portion (open end portion) of the heat insulating container 1c to be freely movable up and down. The left end portion (open end portion) of the heat insulating container 1c is opened in the raised state, and the left end portion (open end portion) of the heat insulating container 1c is closed in the lowered state.

The first elevator 1e is a drive mechanism which raises and lowers the first heat insulating door 1d. A chain engaged with the upper end of the first heat insulating door 1d, a sprocket meshing with the chain, an electric motor (a raising and lowering power source) which rotationally drives the sprocket, and the like are provided in the first elevator 1e. The first elevator 1e raises and lowers the first heat insulating door 1d, which is suspended in a vertical posture by power generated by the raising and lowering power source.

The second heat insulating door 1f is a plate-like member formed of a heat insulating material similar to that of the heat insulating container 1c, and is provided in a vertical posture at the right end portion (open end portion) of the heat insulating container 1c. The second heat insulating door 1f is provided at the right end portion (open end portion) of the heat insulating container 1c to be freely movable up and down.

The second heat insulating door 1f opens the right end portion (open end portion) of the heat insulating container 1c in the raised state, and closes the right end portion (open end portion) of the heat insulating container 1c in the lowered state.

The second elevator 1g is a drive mechanism which raises and lowers the second heat insulating door 1f. A chain engaged with the upper end of the second heat insulating door 1f, a sprocket meshing with the chain, an electric motor (raising and lowering power source) which rotationally drives the sprocket, and the like are provided in the second elevator 1g. The second elevator 1g raises and lowers the second heat insulating door 1f, which is suspended in a vertical posture by the power generated by the raising and lowering power source.

As shown in the figure, the heater 1h is a plurality of electric heaters provided in the upper portion and the lower portion in the heat insulating container 1c at predetermined intervals. The heater 1h generates heat when electric power is supplied from a heater power supply (not shown in the figure), and heats the periphery of the object X to be treated housed in the heat insulating container 1c. The heater 1h convectively heats the object X to be treated in cooperation with a stirring device 1k to be described later.

As shown in the figure, the mounting table 1i is a flat plate-like member placed horizontally on the upper side of the heater 1h in the lower portion of the heat insulating container 1c. The object X to be treated housed in the vacuum chamber 1a (inside the heat insulating container 1c) is mounted on the mounting table 1i from the carrying-in-and-out door 1b. The loading and unloading mechanism 1j is a moving mechanism which moves the object X to be treated between the moisture removal chamber 1 and the heating and cooling chamber 2 via the middle door 3.

That is, the loading and unloading mechanism 1j moves the object X to be treated placed on the mounting table 1i in the vacuum chamber 1a (inside the heat insulating container 1c) into the heating and cooling chamber 2 via the middle door 3, and moves the object X to be treated in the heating and cooling chamber 2 onto the mounting table 1i in the moisture removal chamber 1 (inside the vacuum chamber 1a) via the middle door 3.

Specifically, the loading and unloading mechanism 1j includes a fork which can move in the up-down direction and the left-right direction. The fork can support the object X to be treated on the mounting table 1i from below by moving upward. By moving to the right side (the side of the heating and cooling chamber 2) in this state, the fork can move the supported object X to be treated into the heating and cooling chamber 2 via the middle door 3 without interfering with the heater 1h. Further, by performing the reverse operation, it is possible to move the supported object X to be treated from the heating and cooling chamber 2 onto the mounting table 1i without interfering with the heater 1h.

An opening and closing lid is provided at the bottom of the vacuum chamber 1a. This lid is formed of the same heat insulating material as the heat insulating container 1c, and when the fork moves upward, the lid is opened, the object X to be treated can be supported by the fork, and the object X to be treated can be moved between the mounting table 1i and the heating and cooling chamber 2. Meanwhile, when the fork moves downward, the lid is closed, and the airtightness of the vacuum chamber 1a is maintained.

The stirring device 1k is a convection generating device which generates convection in the heat insulating container 1c, and is equipped with a stirring blade 1m and a drive mechanism 1n. The stirring blade 1m is a cylindrical rotary blade (centrifugal fan) provided in the heat insulating container 1c below the heater 1h. The direction of the stirring blade 1m is set such that the rotation center is in the up-down direction in the drawing, that is, in the vertical direction. The drive mechanism 1n is a driving device that rotationally drives the stirring blade 1m, and includes an electric motor as a power source, a transmission interposed between the electric motor and the stirring blade 1m, and the like.

When the stirring device 1k operates, convection occurs in the heat insulating container 1c. That is, the stirring blade 1m is rotationally driven by the drive mechanism 1n, and sucks up the gas in the heat insulating container 1c from the lower side and blows the gas out laterally, thereby generating convection in the vertical direction in the heat insulating container 1c.

The heating and cooling chamber 2 is provided adjacent to the moisture removal chamber 1, and subjects the object X to be treated received from the moisture removal chamber 1 to heat treatment and cooling treatment, thereby subjecting the object X to be treated to thermal treatment. A vacuum chamber 2a, a heat insulating container 2b, a third heat insulating door 2c, a third elevator 2d, a fourth heat insulating door 2e, a fourth elevator 2f, a fifth heat insulating door 2g, a traversing machine 2h, a heater 2i, a mounting table 2j, and a cooler 2k are provided in the heating and cooling chamber 2.

Like the vacuum chamber la of the moisture removal chamber 1, the vacuum chamber 2a is a horizontally placed cylindrical metal container having airtightness and constitutes a wall body of the heating and cooling chamber 2. The heat insulating container 2b is a substantially cubic container formed of a heat insulating material similar to that of the heat insulating container 1c of the moisture removal chamber 1, and is housed in the vacuum chamber 2a. The object X to be treated carried into the vacuum chamber 2a from the moisture removal chamber 1 via the middle door 3 is housed inside the heat insulating container 2b.

The heat insulating container 2b has an open left end portion, and an opening formed in a bottom portion and an upper portion. The third heat insulating door 2c is a plate-like member formed of a heat insulating material similar to that of the heat insulating container 2b, and is provided at the left end portion (open end portion) of the heat insulating container 2b in a vertical posture. The third heat insulating door 2c is provided at the left end portion (open end portion) of the heat insulating container 2b to be freely movable up and down. The third heat insulating door 2c opens the left end portion (open end portion) of the heat insulating container 2b in the raised state, and closes the left end portion (open end portion) of the heat insulating container 2b in the lowered state.

The third elevator 2d is a drive mechanism that raises and lowers the third heat insulating door 2c. Like the first heat insulating door 1d of the moisture removal chamber 1, the third elevator 2d includes a chain engaged with the upper end of the third heat insulating door 2c, a sprocket meshing with the chain, an electric motor (raising and lowering power source) that rotationally drives the sprocket, and the like. The third elevator 2d raises and lowers the third heat insulating door 2c, which is suspended in the vertical posture by the power generated by the raising and lowering power source.

The fourth heat insulating door 2e is a plate-like member formed of a heat insulating material similar to that of the heat insulating container 2b, and is provided to be freely movable up and down. The fourth heat insulating door 2e has a shape matching the opening (bottom opening) formed in the bottom portion of the heat insulating container 2b, closes the bottom opening in the raised state as shown in the figure, and opens the bottom opening in the lowered state. That is, the bottom opening and the fourth heat insulating door 2e are disposed to face each other in the horizontal posture, the fourth heat insulating door 2e is brought into contact with the heat insulating container 2b from the lower side to close the bottom opening, and the fourth heat insulating door 2e is separated from the heat insulating container 2b to open the bottom opening.

The fourth elevator 2f is a drive mechanism that raises and lowers the fourth heat insulating door 2e. Specifically, the fourth elevator 2f is an elevating cylinder mechanism. When a distal end portion of a movable rod provided so that a movable shaft is in the up-down direction is engaged with the lower surface of the fourth heat insulating door 2e, the fourth elevator 2f supports the fourth heat insulating door 2e and moves it up and down.

The fifth heat insulating door 2g is a plate-like member formed of a heat insulating material similar to that of the fourth heat insulating door 2e, and is provided to be freely movable. The fifth heat insulating door 2g has a shape matching the opening (upper opening) formed in the upper portion of the heat insulating container 2b, and moves in a lateral direction (horizontal direction) to close or open the upper opening. That is, the upper opening and the fifth heat insulating door 2g are disposed to face each other in the horizontal posture, and the fifth heat insulating door 2g moves over the upper opening to close the upper opening, or the fifth heat insulating door 2g moves to the position deviated from the upper opening to open the upper opening.

The traversing machine 2h is a drive mechanism which moves the fifth heat insulating door 2g in the lateral direction (horizontal direction). Specifically, the traversing machine 2h is a traversing cylinder mechanism, and when the distal end portion of a movable rod provided so that the movable shaft is in the horizontal direction is engaged with the side portion of the fifth heat insulating door 2g, the traversing machine 2h horizontally moves the fifth heat insulating door 2g.

As shown in the figure, the heater 2i is an electric heater disposed in the upper portion, both side portions and the lower portion in the heat insulating container 2b, and a plurality of (e.g., six) electric heaters are provided in the horizontal direction at predetermined intervals. The heater 2i is a rectangular frame-like electric heater disposed to surround the object X to be treated housed in the heat insulating container 2b, generates heat when electric power is supplied from a heater power source (not shown in the figure), and uniformly heats the object X to be treated housed in the heat insulating container 2b from the upper portion, both side portions, and the lower portion.

As shown in the figure, the mounting table 2j is a flat plate-like member disposed horizontally on the upper side of the heater 2i at the lower portion in the heat insulating container 2b. The object X to be treated housed in the vacuum chamber 2a (inside the heat insulating container 2b) is mounted on the mounting table 2j by the loading and unloading mechanism 1j of the moisture removal chamber 1.

The cooler 2k is a device which imparts a cooling function to the heating and cooling chamber 2, and includes a coolant chamber 2m, a cooling fan 2n, an electric motor 2p, and a heat exchanger 2q. The coolant chamber 2m is a container having a predetermined capacity which receives the cooling gas supplied from a second nitrogen tank 7, and is provided in the upper portion of the vacuum chamber 2a in communication with the vacuum chamber 2a. The cooling fan 2n is a rotary blade provided above the upper opening of the heat insulating container 2b (above the fifth heat insulating door 2g). The direction of the cooling fan 2n is set such that the center of rotation is in the up-down direction in the drawing, that is, the vertical direction.

The electric motor 2p is a power source which rotationally drives such a cooling fan 2n, and rotates the cooling fan 2n at a predetermined rotational speed. As shown in the figure, the heat exchanger 2q is provided at the side of the cooling fan 2n, and cools the cooling gas supplied to the vacuum chamber 2a via the coolant chamber 2m by exchanging heat with a predetermined refrigerant. The cooling gas is supplied to the vacuum chamber 2a at the time of cooling of the object X to be treated after the heat treatment in the heating and cooling chamber 2, however, the cooling gas is heated by the heat of the object X to be treated. The heat exchanger 2q is an apparatus for effectively cooling the cooling gas heated by the object X to be treated in this way.

Like the aforementioned carrying-in-and-out door 1b, the middle door 3 is a slide door which is provided in the vertical posture and is freely slidable in the left-right direction when viewed from the front. The middle door 3 is supported by the vacuum chamber 1a of the moisture removal chamber 1, allows the inside of the moisture removal chamber 1 (inside of the vacuum chamber 1a) to communicate with the inside of the heating and cooling chamber 2 (inside of the vacuum chamber 2a) in the open state, and blocks the communication between the inside of the moisture removal chamber 1 (inside of the vacuum chamber 1a) and the inside of the heating and cooling chamber 2 (inside of the vacuum chamber 2a) in the closed state.

The first vacuum pump 4 is provided to communicate with the vacuum chamber 1a of the moisture removal chamber 1, and exhausts the gas in the moisture removal chamber 1 (in the vacuum chamber 1a) in the sealed state to the outside, thereby creating a predetermined vacuum atmosphere inside the moisture removal chamber 1 (inside the vacuum chamber 1a). The first nitrogen tank 5 is also provided to communicate with the vacuum chamber 1a of the moisture removal chamber 1, and supplies nitrogen gas to the inside of the moisture removal chamber 1 (inside of the vacuum chamber 1a) in the sealed state, thereby creating a nitrogen gas atmosphere (inert gas atmosphere) inside the moisture removal chamber 1 (inside the vacuum chamber 1a). The first nitrogen tank 5 is an inert gas supply unit in the present embodiment.

Here, an outlet (exhaust port) of the first vacuum pump 4 in the vacuum chamber 1a is provided in the upper portion of the vacuum chamber 1a as shown in the figure. In contrast, an inlet (supply port) of nitrogen gas supplied by the first nitrogen tank 5 is provided in the lower portion of the vacuum chamber 1a. That is, the exhaust port and the supply port are provided in the vacuum chamber 1a to have a positional relationship in which they are separated as far as possible.

The second vacuum pump 6 is provided to communicate with the vacuum chamber 2a of the heating and cooling chamber 2 and exhausts the gas in the inside of the heating and cooling chamber 2 (inside of the vacuum chamber 2a) in the sealed state to the outside, thereby creating a predetermined vacuum atmosphere inside the heating and cooling chamber 2 (inside of the vacuum chamber 2a) to. The second nitrogen tank 7 is also provided to communicate with the vacuum chamber 2a of the heating and cooling chamber 2, and supplies nitrogen gas to the inside of the heating and cooling chamber 2 (inside of the vacuum chamber 2a) in the sealed state, thereby creating a nitrogen gas atmosphere (inert gas atmosphere) inside the heating and cooling chamber 2 (inside the vacuum chamber 2a) to.

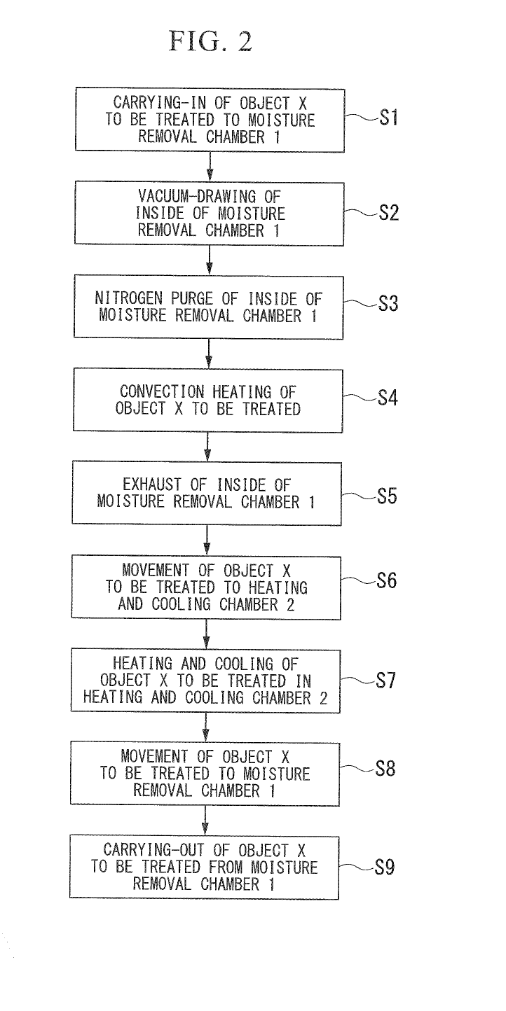

Next, the operation of the two-chamber type thermal treatment device configured in this way will be described in detail with reference to FIG. 2.

In this two-chamber type thermal treatment device, by manipulating the carrying-in-and-out door 1b to the open state, the object X to be treated is inserted into the moisture removal chamber 1 (into the vacuum chamber 1a) and is mounted on the mounting table 1i (step S1). Further, at this stage, when the middle door 3 is in the closed state and the carrying-in-and-out door 1b is manipulated to the closed state, the inside of the moisture removal chamber 1 (inside of the vacuum chamber 1a) is in a sealed state.

In this state, when the first vacuum pump 4 starts to operate, the inside of the moisture removal chamber 1 (inside of the vacuum chamber 1a) is gradually depressurized (evacuated) (step S2). During the decompression in the moisture removal chamber 1 (in the vacuum chamber 1a) by the first vacuum pump 4, moisture adhering to the object X to be treated is gradually vaporized, flows out of the exhaust port to the first vacuum pump 4 as water vapor, and is removed from the surface of the object X to be treated.

Further, when a predetermined time has elapsed from the start of depressurization by the first vacuum pump 4, supply of nitrogen gas from the first nitrogen tank 5 to the inside of the moisture removal chamber 1 (inside of the vacuum chamber 1a) is started (step S3). Since the supply of nitrogen gas is performed from the supply port separated from the exhaust port, the water vapor residing in the moisture removal chamber 1 (in the vacuum chamber 1a) is extruded by nitrogen gas, and is exhausted to the outside of the moisture removal chamber 1 (outside of the vacuum chamber 1a), and the water vapor atmosphere in the moisture removal chamber 1 (in the vacuum chamber 1a) is replaced (nitrogen purged) by the nitrogen gas atmosphere. Since water vapor residing in the moisture removal chamber 1 (in the vacuum chamber 1a) returns to the outside due to the nitrogen purge, vaporization of moisture adhering to the object X to be treated is further promoted.

While the supply of nitrogen gas is continued, when energization to the heater 1h is started and the stirring device 1k starts to operate in succession, convection heating of the object X to be treated is performed (step S4). That is, in a state in which the inside of the vacuum chamber 1a, that is, the atmosphere of the object X to be treated, is a nitrogen gas atmosphere, the object X to be treated and the nitrogen gas are heated by the heater 1h, and the nitrogen gas is convected by the action of the stirring device 1k to convectively heat the object X to be treated.

The nitrogen gas in the heated state and in the convection state enters a deep part of the object X to be treated and effectively vaporizes moisture adhering to such a part.

Therefore, the removal of moisture adhering to the object X to be treated is further promoted by convection heating of the object X to be treated with the nitrogen gas. The heating temperature of the object X to be treated under the supply of nitrogen gas in the step S4 is generally approximately 150° C.

When the convection heating of the object X to be treated over a predetermined time is completed, the nitrogen gas convecting in the moisture removal chamber 1 (in the vacuum chamber 1a) is exhausted to the outside of the moisture removal chamber 1 (outside of the vacuum chamber 1a) due to the action of the first vacuum pump 4, and the inside of the moisture removal chamber 1 (inside of the vacuum chamber 1a) becomes a predetermined vacuum atmosphere. In this state, the middle door 3, the second heat insulating door 1f, and the third heat insulating door 2c are manipulated to shift them from the closed state to the open state. Furthermore, when the loading and unloading mechanism 1j of the moisture removal chamber 1 is operated, the object X to be treated moves from the moisture removal chamber 1 to the heating and cooling chamber 2 (step S6).

That is, after the moisture is sufficiently removed in the moisture removal chamber 1, the object X to be treated is charged into the heating and cooling chamber 2. While the moisture removal treatment in the moisture removal chamber 1 is performed, the second vacuum pump 6 of the heating and cooling chamber 2 is operated, and the inside of the heating and cooling chamber 2 (inside of the vacuum chamber 2a) is depressurized to the pressure necessary for quenching of the object X to be treated, that is, the vacuum atmosphere equivalent to that of the inside of the moisture removal chamber 1 (inside of the vacuum chamber 1a) in the step S6.

Further, by manipulating the middle door 3, the second heat insulating door 1f and the third heat insulating door 2c to shift them from the open state to the closed state, the inside of the heating and cooling chamber 2 (the inside of the vacuum chamber 2a) is sealed. Further, the object X to be treated is subjected to heating and cooling in the heating and cooling chamber 2 (step S7). That is, by starting the energization to the heater 2i of the heating and cooling chamber 2, the object X to be treated is heated to a predetermined temperature required for quenching, and the heating state over a predetermined period is continued in the state in which the predetermined temperature is maintained.

Further, when the heating treatment of the object X to be treated is completed, the energization to the heater 2i of the heating and cooling chamber 2 is stopped, and nitrogen gas is supplied as cooling gas into the inside of the heating and cooling chamber 2 (inside of the vacuum chamber 2a) from the second nitrogen tank 7. Furthermore, when the cooler 2k starts to operate, the nitrogen gas (cooling gas) circulates inside the heating and cooling chamber 2 (inside the vacuum chamber 2a), thereby cooling the object X to be treated. The quenching treatment of the object X to be treated is completed by such heating and cooling in the heating and cooling chamber 2.

When the quenching treatment of the object X to be treated is completed in this manner, the middle door 3, the second heat insulating door 1f and the third heat insulating door 2c are manipulated to shift them from the closed state to the open state, and the loading and unloading mechanism 1j of the moisture removal chamber 1 is operated. Thus, the object X to be treated moves from the heating and cooling chamber 2 to the moisture removal chamber 1 (step S8). Further, after the inside of the moisture removal chamber 1 (the inside of the vacuum chamber 1a) is restored to normal pressure, the carrying-in-and-out door 1b is manipulated to be in the open state, and then, the object X to be treated is carried to the outside from the inside of the moisture removal chamber 1 (inside of the vacuum chamber 1a).

According to the present embodiment, it is possible to remove the moisture adhering to the object X to be treated in the moisture removal chamber 1 more reliably than in the conventional case. As a result, it is possible to reduce oxidation and coloration of the surface of the object X to be treated, which is generated due to moisture when it is thermal-treated in the heating and cooling chamber 2, more than in the conventional case.

Further, the heat insulating container 1c, the first heat insulating door 1d, the first elevator 1e and the second heat insulating door 1f which form the moisture removal chamber 1 (vacuum chamber 1a), and the heat insulating container 2b, the third heat insulating door 2c, the third elevator 2d, the fourth heat insulating door 2e, the fourth elevator 2f and the fifth heat insulating door 2g which form the heating and cooling chamber 2 (vacuum chamber 2a) are all formed of the heat insulating material. Thus, the inner surfaces of the moisture removal chamber 1 and the heating and cooling chamber 2 are completely covered with the heat insulating material to enhance the heat insulating properties of the moisture removal chamber 1 and the heating and cooling chamber 2. Further, inside the moisture removal chamber 1 and the heating and cooling chamber 2, in which the heat insulating properties are enhanced as described above, the heater 1h or the heater 2i is installed to surround the object X to be treated charged into the moisture removal chamber 1 or the heating and cooling chamber 2.

Therefore, at the time of the convection heating of the object X to be treated in the moisture removal chamber 1 and the heating treatment of the object X to be treated in the heating and cooling chamber 2, the heat radiation from the moisture removal chamber 1 and the heating and cooling chamber 2 is reduced, and the heating efficiency improves. Further, the temperature distribution inside the moisture removal chamber 1 and the heating and cooling chamber 2 is homogenized, and it is possible to evenly and uniformly heat the object X to be treated charged in the moisture removal chamber 1 and the heating and cooling chamber 2. As a result, the quality of the object X to be treated after the thermal treatment is improved.

Further, the present disclosure is not limited to the above embodiment, and for example, the following modifications are considered.

(1) In the above embodiment, moisture adhering to the object X to be treated is removed in the three types of treatment of steps S2 to S4, however, the present disclosure is not limited thereto. The moisture removal performance in step S2 differs depending on the time or pressure required for evacuation, however, most of the moisture adhering to the surface of the object X to be treated is vaporized due to decompression in step S2 to become water vapor and is sequentially exhausted to the outside of the vacuum chamber 1a. Therefore, either step S3 or step S4 may be omitted if necessary, or both step S3 and step S4 may be omitted if necessary.

For example, in the case of performing steps S2 and S4 while omitting step S3, when step S4 is performed, the inside of the vacuum chamber 1a is not a nitrogen atmosphere, however, water vapor naturalized from the surface of the object X to be treated slightly remains. Therefore, even if the heater 1h is energized in step S4, it is not possible to expect the convection heating. Therefore, in this case, the object X to be treated is heated by radiation from the heater 1h.

(2) In the above embodiment, the case of performing the quenching treatment in the heating and cooling chamber 2 has been described, however, the present disclosure is not limited thereto. In the heating and cooling chamber 2, thermal treatment other than quenching treatment, for example, solid solution treatment, magnetic treatment, aging treatment, carburizing treatment or nitriding treatment may be performed.

(3) Further, the heating and cooling chamber 2 may be a heating chamber exclusively for heating. For example, the moisture removal chamber 1 has a function of cooling the object X to be treated, and in addition to the moisture removal function of the object X to be treated before the heat treatment, the cooling treatment of the object X to be treated after the heat treatment may be performed by the moisture removal chamber.

(4) In the above embodiment, the vacuum pumps (first and second vacuum pumps 4 and 6) and the nitrogen tanks (first and second nitrogen tanks 5 and 7) are individually provided in the moisture removal chamber 1 and the heating and cooling chamber 2, however, the present disclosure is not limited thereto. A configuration may be adopted in which a single vacuum pump and a single nitrogen tank are provided, a switching valve to selectively connect the vacuum pump to the moisture removal chamber 1 or the heating and cooling chamber 2 is provided, or a switching valve to selectively connect the nitrogen tank to the moisture removal chamber 1 or the heating and cooling chamber 2 is provided.

(5) In the above embodiment, the first nitrogen tank 5 is provided as the inert gas supply unit, however, the present disclosure is not limited thereto. Another inert gas instead of the nitrogen gas may be supplied to the moisture removal chamber 1.

Further, the second nitrogen tank 7 may also be changed to supply an inert gas other than nitrogen gas to the heating and cooling chamber 2.

(6) In the above embodiment, nitrogen gas is supplied from the first nitrogen tank 5 to the moisture removal chamber 1 (vacuum chamber 1a), however, the present disclosure is not limited thereto. For example, in the case of providing a temperature control unit which adjusts the temperature in the moisture removal chamber 1 (the vacuum chamber 1a) to be equal to or lower than the oxidation temperature of the object X to be treated, in place of nitrogen gas, atmospheric air (air) may be introduced into the moisture removal chamber 1. That is, in this case, the surface of the object X to be treated is not oxidized even when it is exposed to the atmosphere (air atmosphere).

For example, when the object X to be treated is an iron-based object, the oxidation temperature is generally around 350° C. Therefore, as long as the surface temperature of the object X to be treated is kept at 350° C. or less by the temperature control unit, it is not necessary to introduce nitrogen gas into the moisture removal chamber 1. However, the temperature largely differs depending on the material of the object to be treated. For example, when the object X to be treated is stainless steel, in order to prevent oxidation or coloration of the surface of the object X to be treated, it is necessary to maintain the surface temperature of the object X to be treated at 300° C. or less.

### INDUSTRIAL APPLICABILITY

When the object to be treated is thermal-treated by the thermal treatment device, it is possible to reduce oxidation or coloration of the surface of the object to be treated generated due to moisture more reliably than in the conventional case.

What is claimed is:

1. A thermal treatment device comprising:
a heating chamber which heats an object to be treated; and
a moisture removal chamber which is provided adjacent to the heating chamber to put in and out of the object to be treated toward the heating chamber, and in which a vacuum atmosphere is created in the periphery of the object to be treated.

2. The thermal treatment device according to claim 1, wherein the moisture removal chamber further comprises one of a heating unit configured to heat the object to be treated or an inert gas supply unit configured to create an inert gas atmosphere in the periphery of the object to be treated, or both the heating unit and the inert gas supply unit.

3. The thermal treatment device according to claim 2, wherein, when the moisture removal chamber comprises one of the heating unit or the inert gas supply unit, after the vacuum atmosphere is created in the periphery of the object to be treated, the inert gas atmosphere is created in the periphery of the object to be treated using the inert gas supply unit, or the object to be treated is heated using the heating unit.

4. The thermal treatment device according to claim 2, wherein, when the moisture removal chamber comprises both the heating unit and the inert gas supply unit, after the vacuum atmosphere is created in the periphery of the object to be treated, the inert gas atmosphere is created in the periphery of the object to be treated using the inert gas supply unit, and the object to be treated is heated using the heating unit.

5. The thermal treatment device according to claim 2, further comprising:
a temperature control unit which sets the inside of the moisture removal chamber to be equal to or lower than an oxidation temperature of the object to be treated; and
an atmospheric air supply unit which creates an atmosphere in the periphery of the object to be treated, instead of the inert gas supply unit.

6. The thermal treatment device according to claim 3, further comprising:
a temperature control unit which sets the inside of the moisture removal chamber to be equal to or lower than an oxidation temperature of the object to be treated; and
an atmospheric air supply unit which creates an atmosphere in the periphery of the object to be treated, instead of the inert gas supply unit.

7. The thermal treatment device according to claim 4, further comprising:
a temperature control unit which sets the inside of the moisture removal chamber to be equal to or lower than an oxidation temperature of the object to be treated; and
an atmospheric air supply unit which creates an atmosphere in the periphery of the object to be treated, instead of the inert gas supply unit.

8. The thermal treatment device according to claim 1, wherein the heating chamber further comprises a cooling function of cooling the object to be treated.

9. The thermal treatment device according to claim 2, wherein the heating chamber further comprises a cooling function of cooling the object to be treated.

10. The thermal treatment device according to claim 3, wherein the heating chamber further comprises a cooling function of cooling the object to be treated.

11. The thermal treatment device according to claim 4, wherein the heating chamber further comprises a cooling function of cooling the object to be treated.

12. The thermal treatment device according to claim 6, wherein the heating chamber further comprises a cooling function of cooling the object to be treated.

13. The thermal treatment device according to claim 7, wherein the heating chamber further comprises a cooling function of cooling the object to be treated.
